(19) United States
(12) Patent Application Publication
(10) Pub. No.: US 2002/0183011 A1
(43) Pub. Date: Dec. 5, 2002

(54) Method and apparatus for combined receive and transmit subsystems in cellular communication systems

(75) Inventor: Michael M. Eddy, Santa Barbara, CA (US)

Correspondence Address: LYON & LYON LLP, 633 WEST FIFTH STREET, SUITE 4700, LOS ANGELES, CA, 90071, US

(73) Assignee: Superconductor Technologies, Inc.

(21) Appl. No.: 10/102,612

(22) Filed: Mar. 19, 2002

Related U.S. Application Data
(60) Provisional application No. 60/277,419, filed on Mar. 19, 2001.
(60) Provisional application No. 60/277,418, filed on Mar. 19, 2001.

(51) Int. Cl. H04B 1/00

(52) U.S. Cl. 455/69; 455/13.4; 455/70; 455/14

(57) ABSTRACT

Methods and apparatus are provided for optimizing a receive side subsystem of a cellular communication system with a transmit side subsystem of the system. The receive side subsystem includes one or more superconducting components, preferably a superconducting filter, coupled to an amplifier, preferably a low noise amplifier. The transmit side subsystem includes a transmitter and, preferably, a power amplifier. The system matches and balances the range or radius of the received side subsystem with the range or radius of the transmit side subsystem. As a result, the receive range and the transmit range of the system overlap. A control system configured to match and balance the subsystems is optionally provided.

### CROSS-REFERENCE TO RELATED APPLICATIONS

The present application claims priority under 35 U.S.C. §119(e) from co-pending U.S. Provisional Application Serial No. 60/277,418, entitled “Apparatus and methods for improved tower mount systems for cellular communications,” filed Mar. 19, 2001, and from co-pending U.S. Provisional Application Serial No. 60/277,419, entitled “Method and apparatus for combined receive and transmit subsystems in cellular communication systems,” filed Mar. 19, 2001, the disclosures of which are expressly incorporated herein by reference in their entireties.

### FIELD OF THE INVENTION

This invention relates generally to the field of telecommunications and cellular communications, such as, e.g., cellular telephone communications. More particularly, this invention relates to telecommunications and cellular communications systems, which may include the use of tower mountable superconducting components, configured to balance received signal strength with transmitted signal strength to increase system capacity while reducing dropped and blocked calls.

### BACKGROUND

Radio frequency (RF) equipment have used a variety of approaches and structures for receiving and transmitting radio waves and other signals in selected frequency bands. The type of filtering structure used often depends upon the intended use and the specifications for the radio equipment. For example, dielectric filters may be used for filtering electromagnetic energy in the ultra-high frequency (UHF) band, such as, e.g., those used for cellular communications in the 800+ MHz frequency range. Because of an increase in the number of users utilizing a limited bandwidth, demand has increased for greater frequency selectivity than can be provided by normal or non-superconducting resonator filters, especially for RF signals in the ultra-high frequency bands that may be used for cellular communications. As a result, substantial attention has recently been devoted to the development of high temperature superconducting (HTS) RF filters for use in, for example, cellular telecommunications systems, to accomplish and optimize high frequency selectivity.

Current telecommunications systems may include a receive side subsystem, such as a receiver front-end that incorporates an HTS filter system. A current, prior art telecommunications system 10 incorporating an HTS receiver front-end (not shown), an antenna array 14, and a tower 12 is depicted in FIG. 1. Because the performance of the HTS receiver front-end is enhanced relative to a conventional, non-HTS receiver front-end, the prior art system 10 will generally be able to receive signals from a greater receive coverage area 18 than the transmit coverage area 16 for the system's 10 transmitter. It should be noted that, as drawn, the transmit coverage area 16 is shown slightly above the receive coverage area 18. But, this separation is shown merely for purposes of drawing clarity. In practice, the coverage areas 16, 18 are substantially overlaid. Turning back to the technical deficiencies of the current, prior art system 10, the end result of the larger receive coverage area 18, relative to the transmit coverage area 16, is that users within the receive coverage area 18 will be heard, but will not necessarily be able to receive signals due to the limited capability of the transmitter relative to the HTS receiver front-end. As a further consequence, users in the unbalanced coverage area 20 of the system 10, i.e., where the receive coverage area 18 extends but the transmit coverage area 16 does not, are often dropped, and/or their calls are often blocked. Those of ordinary skill in the art have failed to provide an effective solution to this problem. For example, some current systems incorporating an HTS receiver front-end may address this problem by merely generating a transmit radius that is equivalent to the maximum receive radius. This is undesirable because the transmit side subsystem often does not need to operate at maximum power in order to cover an area equal to the receive radius at any one time.

Thus, it is believed that those of ordinary skill in the art would find a telecommunications system that matched the transmit coverage area with the receive coverage area to be quite useful. Furthermore, it is believed that those skilled in the art would find a tower mounted communications system incorporating HTS components, wherein the system balances the transmit and receive radii, to be useful. Additionally, it is believed that a tower mounted communication system incorporating a dynamically controllable transmit side subsystem to dynamically generate a transmit radius substantially equivalent to a receive radius would be useful.

### SUMMARY OF THE INVENTION

The present invention is directed to methods and systems for transmitting and receiving telecommunications signals. More particularly, the present invention is directed to tower mounted telecommunications systems that preferably incorporate superconducting materials and that balance transmitted and received signals in order to increase the coverage area of the systems while also reducing dropped and blocked calls.

In one aspect of the present invention, a method for optimizing a telecommunications system is provided. A receive side subsystem that may include an HTS receiver front-end is provided within the system. A transmit side subsystem, with may include a power amplifier, is also provided within the system. A receive coverage area of the receive side subsystem is determined. Subsequently, a power of the transmit side subsystem is adjusted in order to generate a transmit signal having a transmit coverage area that is substantially equivalent to the receive coverage area. To adjust the power of the transmit side subsystem, the power amplifier may be operated to generate the appropriate transmit signal strength.

This method of the present invention may also include mounting the receive side subsystem atop a tower. Additionally, the transmit side subsystem may also be mounted atop the tower. When the receive side and the transmit side subsystems are both mounted atop the tower, the receive side subsystem and the transmit side subsystem may be enclosed in a common enclosure.

A power distribution unit that is capable of adjusting the power of the transmit side subsystem may be provided. The power distribution unit may be coupled to the transmit side subsystem. The power distribution unit may also be coupled to the receive side subsystem. The power distribution unit may include a logic unit that is configured to determine the receive coverage area of the receive side subsystem, compare the receive coverage area with the transmit coverage area, and determine the proper strength of a transmit signal having a transmit coverage area substantially equivalent to the receive coverage area.

The receive coverage area may be continuously monitored, and the power of the transmit side subsystem may be continuously varied in order to maintain the transmit coverage area substantially equivalent to the receive coverage area.

In another aspect of the present invention, a method for optimizing a telecommunications system having a tower and a first amplifier with a power per carrier capacity is provided. The first amplifier is removed from the system. Then, an HTS receiver front-end is installed atop the tower. A second amplifier, having a power per carrier capacity of at least substantially twice the power per carrier capacity of the first amplifier, is installed.

The second amplifier may be dynamically controllable. When the second amplifier is dynamically controllable, a receive signal radius of the HTS receiver front-end is determined. A transmit signal radius substantially equivalent to the receive signal radius is then generated by adjusting the power per carrier capacity of the second amplifier. The receive signal radius is continuously monitored. Additionally, the power per carrier capacity of the second amplifier is continuously varied in order to maintain the transmit signal radius substantially equivalent to the receive signal radius.

In one embodiment, the power per carrier capacity of the first amplifier is not greater than substantially 20 watts, and the power per carrier capacity of the second amplifier is at least substantially 40 watts. In another embodiment, the power per carrier capacity of the second amplifier is substantially at least twice the power per carrier capacity of the first amplifier.

A power distribution unit may also be installed within the system. The power distribution unit may be configured to vary the power per carrier capacity of the second amplifier. The power distribution unit may be coupled to the second amplifier. Additionally, the power distribution unit may be coupled to the HTS receiver front-end.

In another aspect of the present invention, a method for optimizing a telecommunications system including a superconducting receive side subsystem having a receive coverage area is provided. A transmit side subsystem is provided within the system. The transmit side subsystem includes a power amplifier, and has a transmit coverage area. The receive coverage area of the receive side subsystem is determined. The receive coverage area is then compared with the transmit coverage area. The transmit coverage area is adjusted so that the transmit coverage area is substantially equivalent to the receive coverage area.

When the receive coverage area is initially greater than the transmit coverage area, a power level of the power amplifier is increased in order to increase the transmit coverage area to an area substantially equal to the receive coverage area. When the receive coverage area is initially less than the transmit coverage area, a power level of the power amplifier is decreased in order to decrease the transmit coverage area to an area substantially equal to the receive coverage area. Additionally, when the receive coverage area and the transmit coverage area are initially substantially equal, the power level of the power amplifier is maintained.

A power distribution unit may be provided within the system. The power distribution unit may include a logic unit configured to determine the receive coverage area of the receive side subsystem, compare the receive coverage area with the transmit coverage area, and determine a transmit signal strength sufficient to produce a transmit coverage area substantially equivalent to the receive coverage area. The power distribution unit may also be coupled to the receive side subsystem. Furthermore, the power distribution unit may be coupled to the transmit side subsystem.

This method may also include continuously repeating the determining the receive coverage area step, comparing the receive coverage area with the transmit coverage area step, and adjusting the transmit coverage area step during the operation of the system.

Other objects and features of the present invention will become apparent from consideration of the following description taken in conjunction with the accompanying drawings.

### DESCRIPTION OF THE DRAWINGS

FIG. 1 illustrates a current, prior art telecommunications system incorporating an HTS receiver front-end that does not account for an extended coverage area of the HTS receiver relative to the smaller coverage area of the transmitter of the prior art system.

FIG. 2a illustrates an embodiment of a telecommunications system having substantially equal transmit and receive coverage areas, according to the present invention.

FIG. 2b illustrates another embodiment of a telecommunications system having substantially equal transmit and receive coverage areas, according to the present invention.

FIG. 3 illustrates an embodiment of a flow process for a method of balancing a transmit coverage area with a receive coverage area, according to the present invention.

FIG. 4 illustrates another embodiment of a flow process for a method of balancing a transmit coverage area with a receive coverage area, according to the present invention.

FIG. 5 illustrates a multiple tower telecommunications system with overlapping receive and transmit coverage areas, according to the present invention.

FIG. 6 shows a software generated comparison of transmit and receive capacity for a non-HTS multiple tower telecommunications system having four towers.

FIG. 7 shows a software generated comparison of transmit and receive capacity for an HTS multiple tower telecommunications system having four towers.

FIG. 8 shows a software generated comparison between transmit and receive capacity for the HTS multiple tower telecommunications system of FIG. 7, wherein the strength of a power amplifier of the transmit side subsystem is increased.

FIG. 9 shows a software generated comparison of transmit and receive area coverage for a non-HTS multiple tower telecommunications system having four towers.

FIG. 10 shows a software generated comparison of transmit and receive area coverage for an HTS multiple tower telecommunications system having four towers.

FIG. 11 shows a software generated comparison of transmit and receive area coverage for the HTS multiple tower telecommunications system of FIG. 10, wherein the strength of a power amplifier of the transmit side subsystem is increased.

### DETAILED DESCRIPTION

The present invention provides systems, processes, and methods for balancing transmitted and received signals in HTS telecommunications systems in order to increase the coverage area of the systems while also reducing dropped and blocked calls.

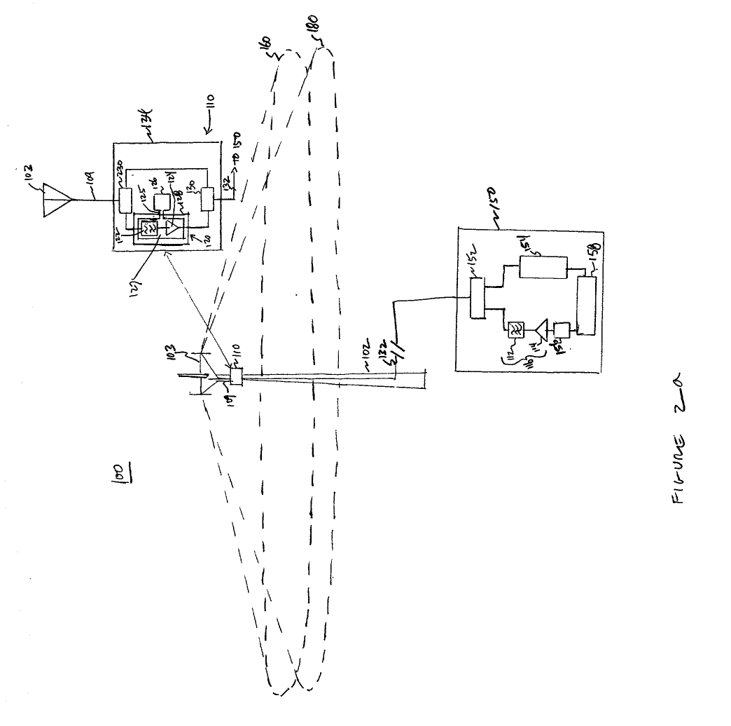

Turning to the preferred embodiments, FIG. 2a illustrates one telecommunications system 100 of the present invention. As shown, the telecommunications system 100 is a tower mounted system. Nevertheless, one skilled in the art will recognize that other configurations for the system 100, such as conventional, non-tower mounted implementations, may be utilized. The system 100 includes a tower or mast 102 and a base station 150 located near the bottom of the tower 102. An antenna or a plurality of antennas 103 is mounted towards the top of the tower 102. In FIG. 2a, an array/plurality of antennas 103 is illustrated. Each antenna may be dedicated to either receiving or transmitting signals. Alternatively, each antenna is used to both transmit and receive signals. Additionally, a single antenna capable of both receiving and transmitting signals may be incorporated in the system 100, rather than the illustrated array or plurality of antennas 103.

A first transmission path 109, which may incorporate a coaxial cable, connects the antennas 103 with a front-end subsystem 110. The front-end subsystem 110 is preferably mounted atop the tower 102 in proximity to the antennas 103, thereby reducing the length of the transmission path 109, and minimizing the cable length required to connect the subsystem 110 with the antennas 103. In an alternative embodiment, the front-end subsystem 110 may be located near or within the base station 150 rather than atop the tower 102.

The front-end subsystem 110 is preferably enclosed within an environmentally protective system housing 134. The housing 134 is designed to isolate the electronics and components of the front-end subsystem 110 from ambient forces. Consequently, any suitable housing capable of insulating the subsystem 110 from external forces and inclement weather is usable for the housing 134. Further, the housing 134 is mountable to the tower 102 using any suitable attachment means, such as, e.g., brackets, placement on a platform, being formed as an integral part of the tower 102, or the like.

The housing 134 protects the front-end subsystem 110, which includes a receive side subsystem 120 and other electronics. For example, if the transmit side subsystem (not shown) is incorporated within the subsystem 110 instead of being located in the base station 150, the housing 134 also protects a transmit filter and a power amplifier. A system having a front-end subsystem that incorporates both the receive side and transmit side subsystems is discussed herein, and illustrated in FIG. 2b.

Turning back to FIG. 2a, the front-end subsystem 110 includes an HTS receive side subsystem 120, such as, e.g., an HTS receiver front-end. The receive side subsystem 120 is also located within the housing 134, and preferably incorporates both an HTS filter 122 and a low noise amplifier 124 (LNA). Although one HTS filter 122 and one LNA 124 is shown in FIG. 2a, a plurality of HTS filters 122 and a plurality of LNAs 124 may be incorporated into the receive side subsystem 120.

The HTS filter 122 is preferably manufactured from a thin-film superconductor, although the present invention also contemplates other constructions such as thick-film superconductors. The thin-film superconductor may, for example, comprise a yttrium containing superconductor known generally as a YBCO superconductor, or, alternatively, a thallium-based superconducting compound. U.S. Pat. No. 6,083,884, entitled, “A-axis high temperature superconducting films with preferential in-plane alignment,” and U.S. Pat. No. 5,358,926, entitled, “Epitaxial thin superconducting thallium-based copper oxide layers,” disclose exemplary thin-film superconductors that may be used with the present invention. The disclosures of the '884 and the '926 patents are fully and expressly incorporated by reference herein. The invention is not, however, limited to a particular type or class of superconductors, i.e., any HTS superconductor that will properly filter RF signals at HTS temperatures may be used in constructing the HTS filter 122.

The receive side subsystem 120 may also incorporate a non-superconducting filter in addition to an HTS filter 122. Such a subsystem is disclosed in co-pending and commonly assigned U.S. patent application Ser. No. 09/818,100, filed Mar. 26, 2001, and entitled, “A filter network combining non-superconducting and superconducting filters.” U.S. patent application Ser. No. 09/818,100 is fully and expressly incorporated by reference herein.

The receive side subsystem 120 further includes a cryocooler 126 that is used to cool the HTS filter 122 and LNA 124, and possibly other electronic components that may be incorporated into the receive side subsystem 120. The cryocooler 126 included with the receive side subsystem 120 may be any suitable cryocooler, such as, e.g., a Stirling cycle cryocooler, a Brayton cycle cryocooler, a Gifford-McMahon cryocooler, a pulse tube cryocooler, and the like. Exemplary cryocoolers are disclosed in U.S. Pat. No. 6,327,862, entitled, “Stirling cycle cryocooler with optimized cold end design,” and U.S. Pat. No. 6,141,971, entitled “Cryocooler motor with split return iron.” The disclosures of the '862 and the '971 patents are fully and expressly incorporated herein by reference. U.S. Pat. No. 6,311,498, entitled “Tower mountable cryocooler and HTSC filter system,” also discusses cryocoolers suitable for use with the present invention. The disclosure of the '498 patent is also fully and expressly incorporated herein by reference.

The cryocooler 126 is thermally coupled at its cold end to a cryogenic enclosure 128 that contains the HTS components and other electronics. The cryogenic enclosure 128 is preferably a vacuum dewar. The use of a vacuum dewar for the cryogenic enclosure 128 minimizes the transfer of heat from the external environment to the inside of the cryogenic enclosure 128.

A cold stage 127 is preferably located within the cryogenic enclosure 128. The cold stage 127 preferably contains thereon the HTS filter 122 and the LNA 124. Optionally, other electronic components that are used in the receive side subsystem 120 may also be located upon the cold stage 127. The cold stage 127 may have a single face, or, optionally, a plurality of faces to hold a number of HTS filters 122 and LNAs 124. A cooling transfer segment or cold finger 125 couples the cold stage 127 with the cryocooler 126. The cooling transfer segment 125 facilitates thermal transfer between the cold stage 127 and the cryocooler 126.

Further details of an exemplary receive side subsystem 120 suitable for use with the present invention are described in co-pending and commonly assigned U.S. application Ser. No. 10/017,147, filed Dec. 13, 2001, and entitled, “MEMS-based bypass system for use with a HTS RF receiver.” The disclosure of U.S. application Ser. No. 10/017,147 is fully and expressly incorporated by reference herein.

The front-end subsystem 110 of system 100 does not include a transmit side subsystem 116. Rather, the transmit side subsystem 116 is located within the base station 150. The transmit side subsystem 116 includes a power amplifier 114 coupled to the transmit electronics 156, which in turn is coupled to a power distribution unit 158. The power amplifier 114 is also coupled to a transmitter filter 112. The transmitter filter 112 may be a conventional, non-superconducting filter. Alternatively, the transmitter filter 112 may incorporate superconducting materials. In this alternative embodiment, suitable cryogenic components are included within the transmit side subsystem 116, similar to the cryogenics incorporated within the receive side subsystem 120. In an alternative embodiment, the transmit side subsystem 116 may be included within the front-end subsystem 110 rather than being placed within the base station 150.

Turning back to the embodiment illustrated in FIG. 2a, transmit signals, as a component of a combined transmit/receive signal, are received by a first front-end multiplexer 130 within the front-end subsystem 110. The first front-end multiplexer 130 separates out the transmit signal component of the combined signal, and delivers the transmit signal to a second front-end multiplexer 230. The second front-end multiplexer 230 then delivers the transmit signal to the antennas 103, via the first transmission path 109, for broadcast into the transmit coverage area 160 of the system 100. As will be discussed, the strength of the transmit signal, i.e., the transmit coverage area 160, is adjusted by the system 100 such that the transmit coverage area 160 is substantially equal to the receive coverage area 180, thereby eliminating or substantially reducing dropped calls or blocked calls within the coverage area of the system 100.

The system 100 preferably includes a second transmission path 132. Like the first transmission path 109, the second transmission path 132 preferably includes a coaxial cable. The second transmission path 132 connects the front-end subsystem 110 with the base station 150. For example, the second transmission path 132 carries a combined transmit/receive signal to and from the base station 150 to the first front-end multiplexer 130.

To process a received RF signal, a RF signal received by the antennas 103 is first delivered to the second front-end multiplexer 230, as a component of a combined transmit/receive signal, via the first transmission path 109. The second front-end multiplexer 230 separates the receive signal from the combined signal and transmits the receive signal to the receive side subsystem 120. Once received by the receive side subsystem 120, the RF signal, i.e., the received signal, is filtered by the HTS filter 122 to remove any signals in unwanted frequencies, and is amplified by the LNA 124. The filtered and amplified RF signal is then relayed to the first transmitter/receiver system multiplexer 130.

The first transmitter/receiver system multiplexer 130 delivers the received signal, as part of a combined transmit/receive signal, to the base station 150, via the second transmission path 132, for further processing. In the base station 150, a base station side multiplexer 152 splits the received signal from the combined signal, and the received signal is provided to receive electronics 154 for processing. The receive electronics 154 are further coupled to a power distribution unit 158, which will be described herein.

Turning now to FIG. 2b, an embodiment of the present invention, system 100(b), that includes the transmit side subsystem 116 mounted atop the tower 102 is shown. As illustrated, the transmit side subsystem 116 is incorporated within front-end subsystem 110(b). Because the transmit side subsystem 116 has been moved to a position atop the tower 102, base station 150(b) no longer contains these components. Components that are common to both system 100 and system 100(b) are identified with like numbers, and reference is made to the description of these components with respect to system 100.

The multiplexers 152, 130, and 230 operate to deliver received signals in a manner substantially similar as described with regard to system 100. Because the transmit side subsystem 116 of system 100(b) is located atop the tower 102 instead of within base station 150(b), the operation of the multiplexers 152, 130, and 230 with regard to transmit signals differs somewhat from system 100. A transmit signal is generated by the transmit electronics 156 within the base station 150(b), and is delivered to the base station side multiplexer 152. The base station side multiplexer 152 delivers the transmit signal to the front-end subsystem 110(b), via the second transmission path 132, as part of a combined transmit/receive signal. Once received by the front-end subsystem 110(b), the first front-end multiplexer 130 splits the transmit signal from the combined transmit/receive signal, and delivers the transmit signal to the transmit side subsystem 116. The transmit side subsystem 116 amplifies and filters the transmit signal in a manner substantially similar as previously described with system 100. The transmit side subsystem 116 then delivers the amplified and filtered transmit signal to the second front-end multiplexer 220. The second front-end multiplexer 220 provides the amplified and filtered transmit signal, via the first transmission path and as part of a combined transmit/receive signal, to the antennas 103 for broadcast.

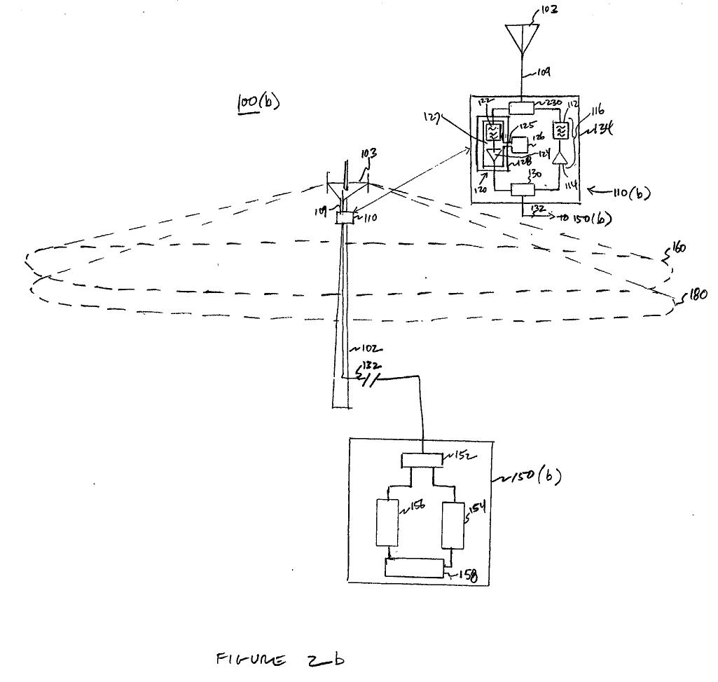

As noted, the present invention optimizes the performance of a telecommunications system by generating substantially equal transmit and receive coverage areas. Exemplary processes of the present invention that ensure substantially equal transmit and receive coverage areas will now be discussed. It should be noted that although the following discussion refers primarily to system 100 this discussion is equally applicable to system 100(b). As previously detailed, the systems of the present invention include transmit electronics 156 coupled to both the transmit side subsystem 116 and the power distribution unit 158. The power distribution unit 158 optimizes the operation of the systems by implementing a logic process 30, as shown in FIG. 3. It is noted that one of ordinary skill in computer programming is capable of developing a program that implements the logic process 30. Consequently, details of a specific program for implement the logic process 30 is not discussed herein.

The power distribution unit 158 preferably incorporates a logic unit (not shown) to implement and operate the logic process 30. The logic unit may include a suitable central processing unit, a memory component suitable for storing the process 30, which may be, e.g., read only memory (ROM), flash memory, non-volatile EEPROM, or the like, a memory component suitable for storing temporary data related to receive and transmit signal strengths, which may be, e.g., random access memory (RAM), flash memory, non-volatile EEPROM, or the like, and input/output components to communicate with the transmit electronics 156 and the receive electronics 154.

Turning to FIG. 3, the logic unit receives a received signal from the receive electronics 154. (Step 32). The logic unit then determines the strength of the received signal. By determining the strength of the received signal, the logic unit also calculates the receive coverage area 180 of the system 100. (Step 34). Utilizing the receive coverage area 180, the logic unit calculates the transmit signal strength necessary to generate a transmit coverage area 160 of substantially the same area as the receive coverage area 180. (Step 36). Once the logic unit determines the proper transmit signal strength to generate the desired transmit coverage area 160, the logic unit instructs the power distribution unit 158 to transmit an appropriate instruction to the transmit electronics 156. (Step 38).

Upon receipt of an instruction from the power distribution unit 158, the transmit electronics 156 generate a transmit signal, and relays the transmit signal to the power amplifier 114. Based on the instruction received from the power distribution unit 158, the transmit electronics 156 also adjusts the power of the power amplifier 114 to an appropriate level. (Step 38, FIG. 3). For example, upon receipt of a command signal from the power distribution unit 158, the transmit electronics 156 may set the power, which may be the power per carrier capacity, of the power amplifier 114 to a level adequate to amplify the transmit signal and generate a transmit coverage area 160 that will substantially match the receive coverage area 180. The power amplifier 114 increases the signal strength of the transmit signal to the desired level, and then relays the amplified transmit signal to the transmitter filter 112. The transmit side subsystem 116 is preferably coupled to the base station side multiplexer 152. Accordingly, the transmit side subsystem 116 provides the base station side multiplexer 152 with the amplified transmit signal. The base station side multiplexer 152 subsequently provides the amplified transmit signal, as a component of a combined transmit/receive signal, to the first front-end multiplexer 130, via the second transmission path 132. Once received by the front-end subsystem 110, the subsystem 110 processes the amplified transmit signal as previously described, and broadcasts the signal to produce the transmit coverage area 160.

Consequently, by executing the process 30 shown in FIG. 3, the power distribution unit 158 ensures that users within an area covered by the system 100 can both transmit and receive RF signals. In other words, the system 100 will produce transmit and receive coverage areas 160, 180 of substantially the same size.

The receive coverage area 180 of the system 100 may vary during the operation of the system 100 due to a number of factors, such as, e.g., an increase in the number of users in the area or a decrease in the number of users in the area. Also, communications systems may utilize protocols that are inherently dynamic, such as, e.g., code division multiple access (CDMA) systems and the like. Accordingly, to compensate for receive coverage areas that may vary during the operation of the system 100, the power distribution unit 158 may be further capable of continuously varying the transmit coverage area 160 to substantially match the receive coverage area 180. To provide for a continuously variable system 100, the power amplifier 114 of the transmit side subsystem 116 is preferably one wherein the power level may be dynamically or continuously adjusted.

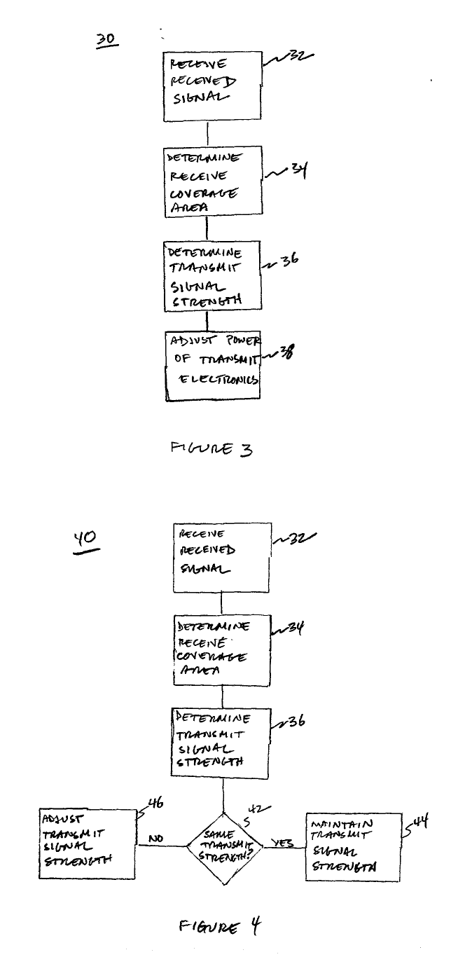

Turning to FIG. 4, a process 40 for varying the transmit coverage area 160 during the operation of the system 100 is illustrated. Steps 32, 34, and 36 are substantially similar to these steps of process 30, and reference is made to the discussion of these steps for process 30 as these steps apply to process 40. Turning specifically to process 40, the logic unit of the power distribution unit 158, after it determines the proper transmit signal strength (Step 36), compares the transmit signal strength with the previous transmit signal strength. (Step 42). If signal strengths are equivalent, the logic unit instructs the power distribution unit 158 to maintain the transmit signal strength constant; the power distribution unit 158 subsequently relays the instruction to the transmit electronics 154. (Step 44). If, however, the logic unit determines that the transmit signal strength has changed, the logic unit instructs the power distribution unit 158 to adjust the transmit signal accordingly; the power distribution unit 158 subsequently relays the instruction to the transmit electronics 154. Here, the transmit signal strength may be decreased if the logic unit determines that the receive coverage area has been reduced. Or, the transmit signal strength may be increased if the logic unit determines that the receive coverage area has increased.

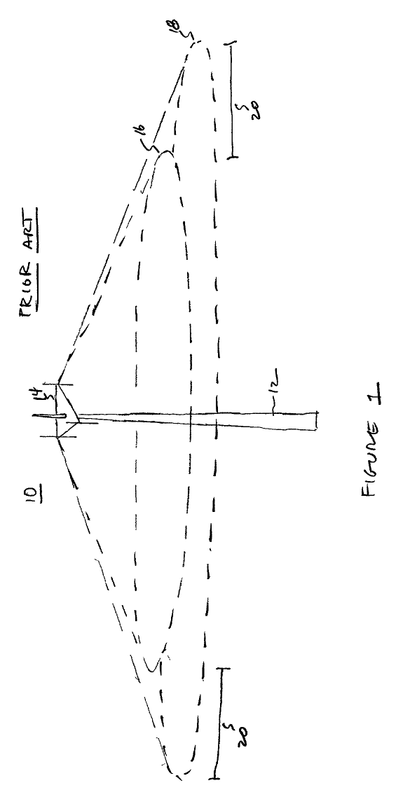

The present invention also provides for a method of retrofitting existing telecommunications systems to provide a system in accordance with the present invention. In one embodiment of this method of retrofitting, the existing telecommunications system may be substantially similar to the prior art system 10 illustrated in FIG. 1. For example, the existing telecommunications system may include a power amplifier that does not exceed 20 watts of power per carrier. The existing system also includes an HTS receiver. The existing HTS receiver is preferably capable of operating at up to substantially 40 watts of power per carrier. Therefore, when this existing telecommunications system is in operation, the receive coverage area may be greater than the transmit coverage area. The problems that may result from this imbalance, such as, e.g., calls being dropped or blocked, have been previously discussed.

The present invention provides for a method of retrofitting this existing telecommunications system by, first, removing the existing power amplifier from the installation. Next, a power amplifier suitable of generating at least substantially 40 watts of power per carrier is installed into the system, thereby replacing the old power amplifier. The power distribution unit 158 is also installed and added to the system, and is coupled to both the transmit and receive electronics of the system. The power distribution unit 158 is then operated to increase the possible power generated by the power amplifier to at least substantially 40 watts per carrier, thereby matching the capacity of the HTS receiver. The power distribution unit 158 implements the process 30 shown in FIG. 3 to enable the system to balance the receive coverage area and the transmit coverage area of the system. Further, the power distribution unit 158 may also implement process 40 as shown in FIG. 4 to continuously vary and adjust the power per carrier capacity of the power amplifier, thereby dynamically adjusting the transmit coverage area relative to the receive coverage area to compensate for any variations in the receive coverage area. Preferably, this retrofit method increases the transmit power of an existing telecommunications system by at least a magnitude of two.

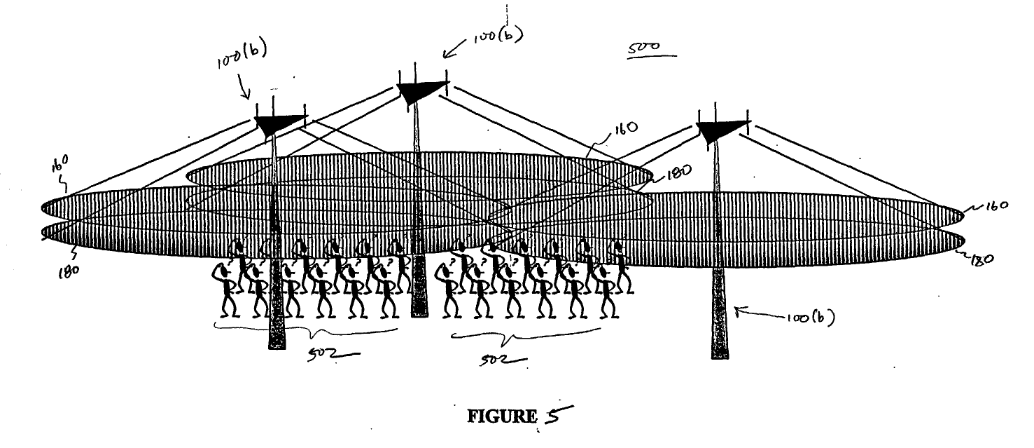

FIG. 5 illustrates a multiple tower telecommunications system 500 with overlapping receive and transmit coverage areas, according to the present invention. As shown, the multiple tower system 500 utilizes a plurality of systems 100(b) that include a receive side subsystem 120 and a transmit side subsystem 116. Both subsystems 120, 116 are both mounted and elevated on a tower 102. Alternatively, the multiple tower system 500 may incorporate a plurality of systems 100, wherein only the receive side subsystems 120 are mounted and elevated on the tower 102. The following discussion will focus on a multiple tower system 500 that includes a plurality of systems 100(b), although it will be appreciated that the discussion applies equally to a multiple tower system 500 having a plurality of systems 100.

Multiple tower system 500 provides for an overlap of transmit coverage areas 160 and receive coverage areas 180 amongst the plurality of systems 100(b). The overlap of the plurality of transmit and receive coverage areas 160, 180 allows for an increased overall capacity for the multiple tower system 500, in comparison to a single system 100(b) in isolation. For example, the overlap between the coverage areas 160, 180 of the systems 100(b) allows the multiple tower system 500 to “handoff” users 502 amongst the plurality of systems 100(b), thereby creating an overall larger coverage area 160,180 for the multiple tower system 500 than would be possible for any single system 100(b). Additionally, the individual systems 100(b) are arrayed such that there are no gaps in any overlapping coverage areas 160, 180. Any gaps in overlapping coverage areas 160, 180 would result in user calls being dropped when a user is within a gapped area.

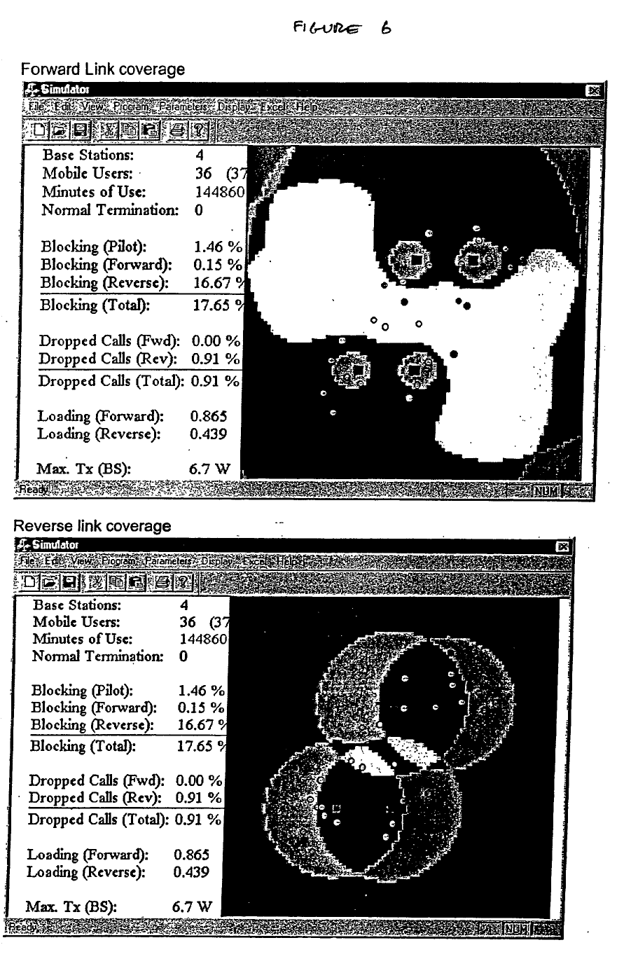

FIGS. 6 to 8 show software generated comparisons of transmit and receive user capacities for a non-HTS multiple tower telecommunications system having four towers, and similar comparisons for an HTS multiple tower system that implements the systems and methods of the present invention.

Turning first to FIG. 6, a software generated comparison of transmit and receive user capacities is shown for a non-HTS system that has a 6 dB noise figure for the receive side subsystems and transmit side subsystems that are operating at 20 W. The transmit capacity for the non-HTS multiple tower system is shown in the top screen shot, with the light area of the screen indicating the transmit capacity range for the non-HTS system. The bottom screen shot of FIG. 6 shows the receive capacity for the same non-HTS system, with the area of overlap between the individual towers shown in the light areas. There is a gap in receive user capacity that is illustrated by the gap between the light areas in the center of the bottom screen shot. When this system is processing 36 users, the system has adequate transmit capacity. The receive capacity is limited, however, and dropped calls, or call blocking, begins occurring at 36 users because of the gap in coverage seen in the bottom screen shot of FIG. 6. Therefore, there is an imbalance between the transmit and receive capacity of this non-HTS system.

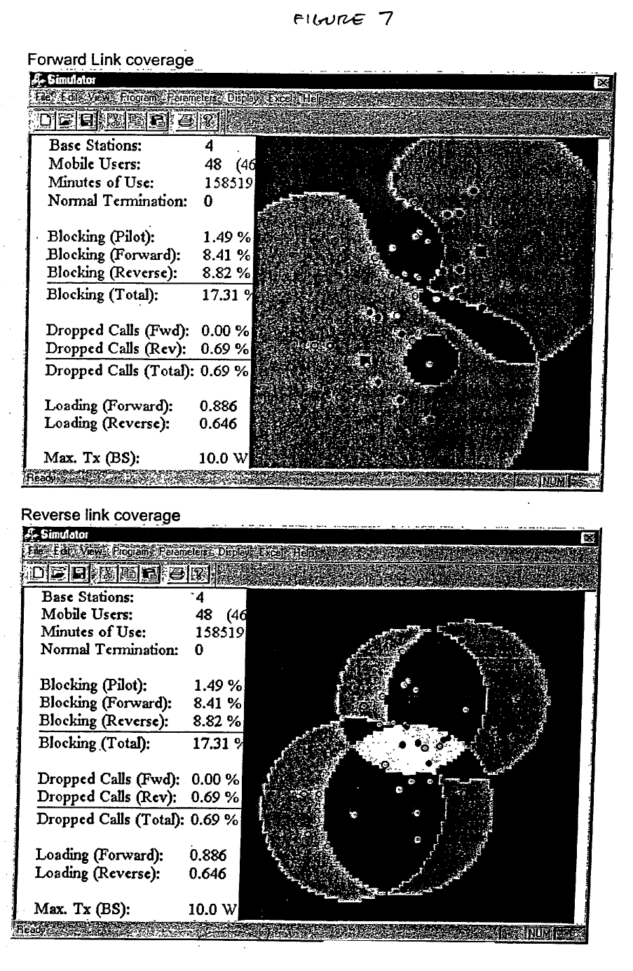

Turning now to FIG. 7, software generated comparisons of transmit and receive user capacities are illustrated for an HTS multiple tower system of the present invention, such as, e.g., system 500. Because the system incorporates HTS filters in the receive side subsystems, the noise figure for the receive side is reduced to 2 dB, assuming a 6 dB noise figure for a comparable, non-HTS system. For FIG. 7, a power level of 20 W is maintained for the transmit side subsystems. Referring to the bottom screen shot, which shows the receive user capacity for the HTS system, the reduced noise figure for the receive side subsystems results in an overlap of receive capacity for all of the individual systems of the multiple tower HTS system, i.e., there are no gaps in receive capacity. With respect to the transmit capacity of the same HTS system, however, gaps in transmit capacity begin to appear when 48 users are employing the system. The gaps in transmit capacity are represented by the dark areas between the larger, lighter areas in the top screen shot. Therefore, the performance of the HTS multiple tower system is limited on the transmit side, not the receive side.

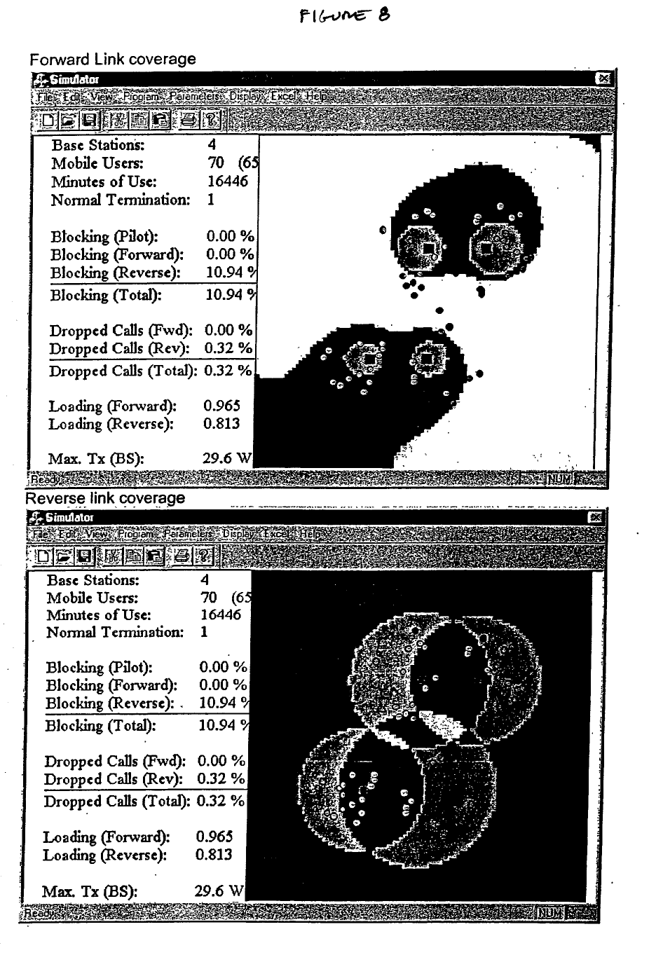

Using the systems methods of the present invention, the transmit capacity of the HTS multiple tower system is adjusted to balance the transmit and receive user capacities. With reference to the system modeled in FIG. 7, FIG. 8 illustrates software generated comparisons of the transmit and receive capacities for the system when, utilizing the systems and methods of the present invention, it is determined that the power to the transmit side subsystems may be increased to 70 W to compensate for the increased performance of the HTS receive side subsystems. The present invention is utilized to determine that the maximum transmit and receive user capacities may be increased to support 70 users without dropped or blocked calls, which in this case requires increasing the power of the transmit side subsystems to 70 W. The transmit user capacity is represented by the light areas in the top screen shot. As is seen in the bottom screen shot, all of the receive user capacities of the individual HTS systems of the multiple HTS tower systems overlap, with no gaps, when 70 users are supported.

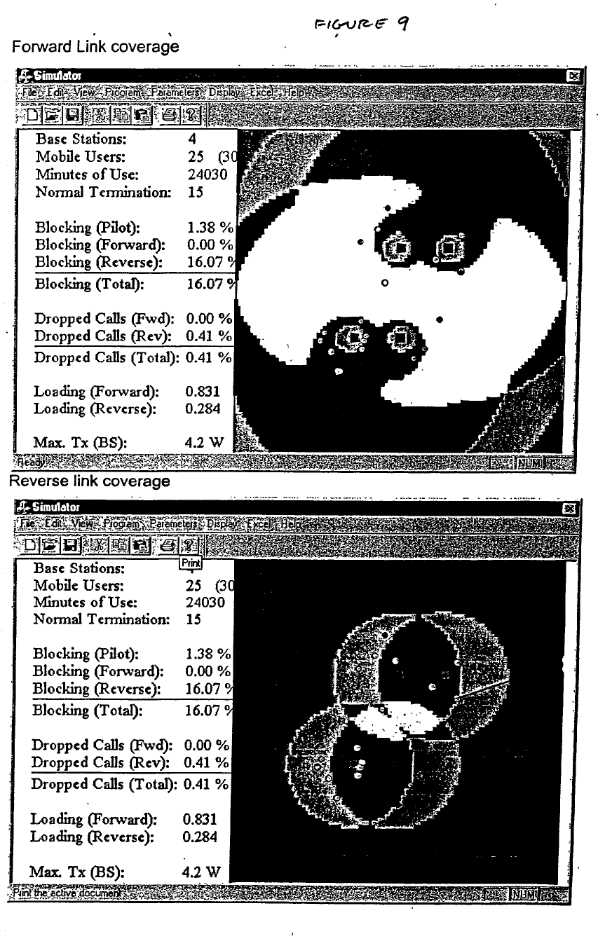

FIGS. 9 to 11 show software generated comparisons of transmit and receive coverage areas (as opposed to the user capacities shown in FIGS. 6 to 8) for a non-HTS multiple tower telecommunications system having four towers, and similar comparisons for an HTS multiple tower system that implements the systems and methods of the present invention. The transmit and receive coverage areas in these figures are for lightly loaded systems, i.e., approximately 21 to 25 users are using the respective systems.

Turning first to FIG. 9, the transmit and receive coverage areas for a non-HTS multiple tower system that does not incorporate the systems and methods of the present invention are shown. The receive side subsystem of this non-HTS system has a 6 dB noise figure, and the transmit side subsystem is operating at 20 W. As seen in the bottom screen shot, the light area indicates the overlap of the receive coverage areas of this non-HTS system. At 25 users, the non-HTS system is limited to a receive coverage area of 15 miles, although the transmit coverage area capacity may be greater. Therefore, this non-HTS system is limited to a coverage area of 15 miles before callers are dropped or blocked due to limitations on the receive side.

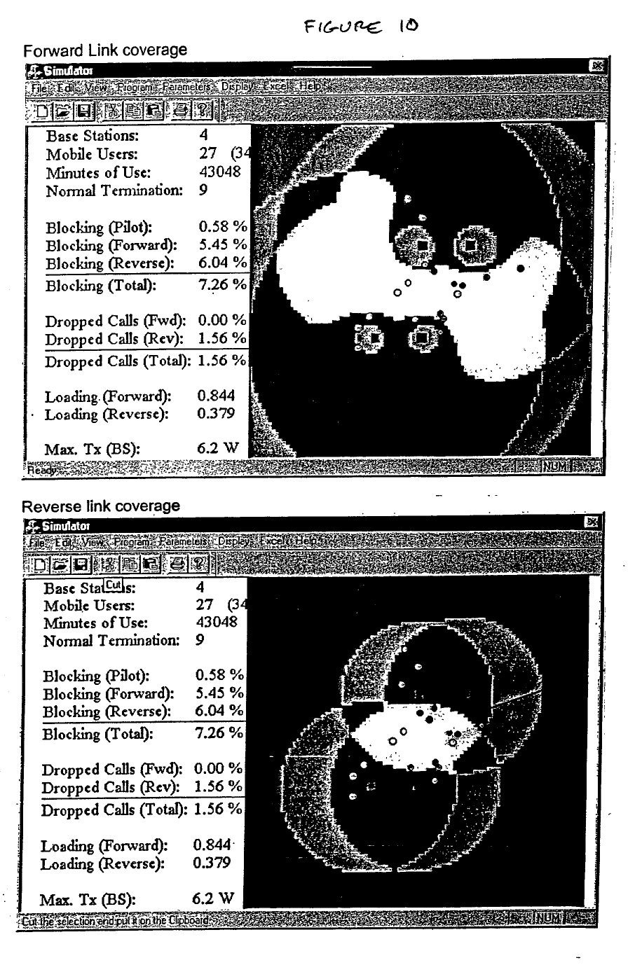

Turning now to FIG. 10, the transmit and receive coverage areas are shown for an HTS multiple tower system that incorporates the present invention. Due to the use of superconducting materials, the noise figure of the receive side subsystems is reduced to 2 dB, in comparison to the non-HTS system discussed with regard to FIG. 9. Because of the lower noise figure, the receive coverage area is increased compared to FIG. 9, as seen in the bottom screen shot by the lighter area.

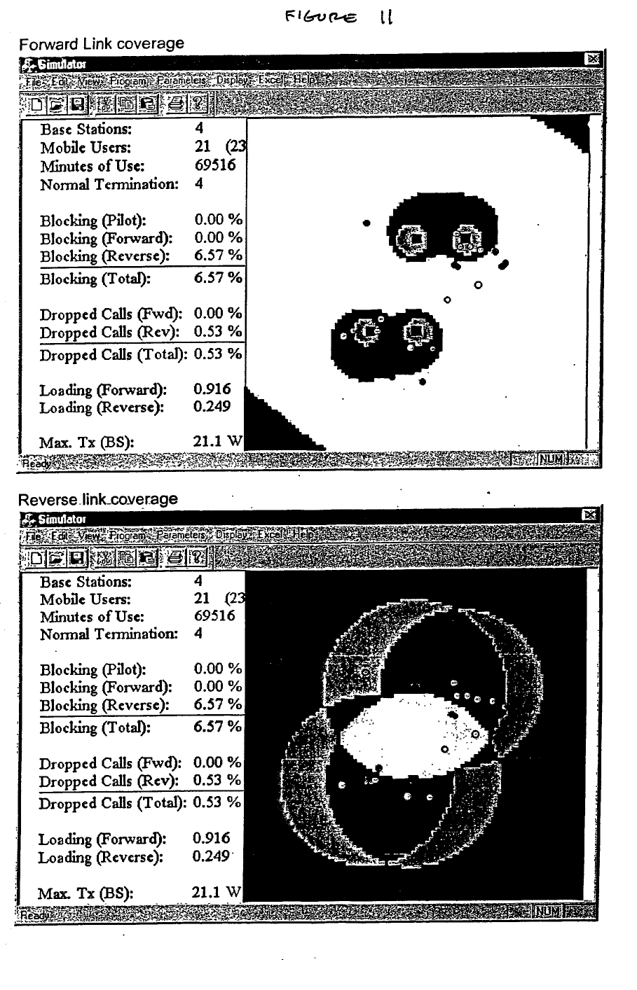

Turning now to FIG. 11, the transmit and receive coverage areas of the HTS system discussed in FIG. 10 is shown when the transmit power is increased to 70 W. The systems and methods of the present invention are used to determine that the transmit power of the transmit side subsystems may be increased to 70 W to increase the transmit coverage area, shown in the top screen shot by the lighter area, while also maintaining a receive coverage area, shown in the bottom screen shot by the lighter area, that does not have any gaps in coverage area.

While the invention is susceptible to various modifications and alternative forms, specific examples thereof have been shown in the figures and are described herein in detail. It should be understood, however, that the invention is not to be limited to the particular forms, systems, or methods disclosed. Furthermore, other aspects and embodiments of the invention will be apparent to those skilled in the art from consideration of the specification and practice of the invention disclosed herein. The invention is intended to cover all modifications, equivalents, and alternatives falling within the spirit and scope of the appended claims.

What is claimed is:

1. A method for optimizing a telecommunications system, comprising the steps of:
providing a receive side subsystem within the system, wherein the receive side subsystem comprises an HTS receiver front-end;
providing a transmit side subsystem within the system, wherein the transmit side subsystem comprises a power amplifier;
determining a receive coverage area of the receive side subsystem; and
adjusting a power of the transmit side subsystem to generate a transmit signal having a transmit coverage area substantially equivalent to the receive coverage area of the receive side subsystem.

2. The method of claim 1, wherein the adjusting the power of the transmit side subsystem comprises operating the power amplifier to generate the transmit signal having a coverage area substantially equivalent to the coverage area of the receive side subsystem.

3. The method of claim 1, wherein the providing the receive side subsystem further comprises mounting the receive side subsystem atop a tower.

4. The method of claim 1, further comprising:
mounting the receive side subsystem atop a tower; and
mounting the transmit side subsystem atop the tower.

5. The method of claim 4, wherein the receive side subsystem and the transmit side subsystem are enclosed in a common enclosure.

6. The method of claim 1, further comprising:
providing a power distribution unit coupled to the transmit side subsystem and the receive side subsystem, wherein the power distribution unit is operable to adjust the power of the transmit side subsystem.

7. The method of claim 6, wherein the power distribution unit comprises a logic unit configured to determine the receive coverage area of the receive side subsystem, compare the receive coverage area with the transmit coverage area, and determine the transmit signal having a transmit coverage area substantially equivalent to the receive coverage area.

8. The method of claim 1, further comprising:
continuously monitoring the receive coverage area; and
continuously varying the power of the transmit side subsystem to maintain the transmit coverage area substantially equivalent to the receive coverage area.

9. A method for optimizing a telecommunications system having a tower and a first amplifier with a power per carrier capacity, comprising:
removing the first amplifier;
installing an HTS receiver front-end atop the tower; and
installing a second amplifier with a power per carrier capacity, wherein the power per carrier capacity of the second amplifier is at least substantially twice the power per carrier capacity of the first amplifier.

10. The method of claim 9, wherein the second amplifier is dynamically controllable, further comprising:
determining a receive signal radius of the HTS receiver front-end;
generating a transmit signal radius substantially equivalent to the receive signal radius by adjusting the power per carrier capacity of the second amplifier;
continuously monitoring the receive signal radius; and
continuously varying the power per carrier capacity of the second amplifier to maintain the transmit signal radius substantially equivalent to the receive signal radius.

11. The method of claim 9, wherein the power per carrier capacity of the first amplifier is not greater than substantially 20 watts, and the power per carrier capacity of the second amplifier is at least substantially 40 watts.

12. The method of claim 9, wherein the power per carrier capacity of the second amplifier is substantially at least twice the power per carrier capacity of the first amplifier.

13. The method of claim 9, further comprising:
installing a power distribution unit within the system, the power distribution unit being configured to vary the power per carrier capacity of the second amplifier;
coupling the power distribution unit to the second amplifier; and
coupling the power distribution unit to the HTS receiver front-end.

14. A method for optimizing a telecommunications system including a superconducting receive side subsystem having a receive coverage area, comprising the steps of:
providing a transmit side subsystem within the system, wherein the transmit side subsystem comprises a power amplifier, the transmit side subsystem having a transmit coverage area;
determining the receive coverage area of the receive side subsystem;
comparing the receive coverage area with the transmit coverage area; and
adjusting the transmit coverage area such that the transmit coverage area is substantially equivalent to the receive coverage area.

15. The method of claim 14, wherein the receive coverage area is initially greater than the transmit coverage area, and the adjusting the transmit coverage area step comprises:
increasing a power level of the power amplifier of the transmit side subsystem to increase the transmit coverage area to an area substantially equal to the receive coverage area.

16. The method of claim 14, wherein the receive coverage area is initially less than the transmit coverage area, and the adjusting the transmit coverage area step comprises:
decreasing a power level of the power amplifier of the transmit side subsystem to decrease the transmit coverage area to an area substantially equal to the receive coverage area.

17. The method of claim 14, wherein the receive coverage area and the transmit coverage area are initially substantially equal, and the adjusting the transmit coverage area step comprises:
maintaining a power level of the power amplifier.

18. The method of claim 14, further comprising:
providing a power distribution unit within the system, the power distribution unit comprising a logic unit configured to determine the receive coverage area of the receive side subsystem, compare the receive coverage area with the transmit coverage area, and determine a transmit signal strength sufficient to produce a transmit coverage area substantially equivalent to the receive coverage area.

19. The method of claim 18, wherein providing the power distribution unit within the system comprises:
coupling the power distribution unit to the receive side subsystem; and
coupling the power distribution unit to the transmit side subsystem.

20. The method of claim 14, further comprising:
continuously repeating the determining the receive coverage area step, comparing the receive coverage area with the transmit coverage area step, and adjusting the transmit coverage area step during operation of the system.
